(19) United States
(12) Patent Application Publication
(10) Pub. No.: US 2008/0218366 A1
(43) Pub. Date: Sep. 11, 2008

(54) SYSTEM AND METHOD FOR PROTECTING PORTABLE ELECTRONIC DEVICES

(75) Inventor: CHIEN-HENG CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/761,187

(22) Filed: Jun. 11, 2007

(30) Foreign Application Priority Data
Mar. 6, 2007 (CN) 200710200253.3

(51) Int. Cl. G08B 21/00

(52) U.S. Cl. 340/669

(57) ABSTRACT

A system for protecting a portable electronic device includes an accelerometer and a processor. The accelerometer is configured to measure an acceleration of the portable electronic device in at least one direction and to generate a signal proportional to the acceleration. The processor is configured to receive the signal from the accelerometer and compare the signal with a preset value to judge whether an unacceptable fall and/or an unacceptable impact is occurring. The processor is further configured to activate a routine to shut down the portable electronic device, if such a fall and/or an impact is occurring. The goal is to prevent, e.g., system shorts that may otherwise occur from impact from potentially further damaging the device.

### BACKGROUND

1. Technical Field

The present invention relates to systems and methods for protecting portable electronic device and, particularly, to a system and a method for protecting portable electronic devices from impact.

2. Description of Related Art

Portable electronic devices are becoming more and more popular and thus more widely used. These electronic devices include computing devices such as notebooks/portable computers and personal digital assistants (PDAs), communication devices such as wireless telephones, and media devices, such as CDs, DVDs, and MP3 players.

However, portable electronic devices are frequently moved. Therefore, there is always a possibility that the portable electronic devices might fall and hit a surface with sufficient force that the portable electronic device would be damaged. The impact may cause some component to, e.g., become deformed and/or break off from a motherboard of the portable electronic device. This impact, as such, may cause an electric circuit of the portable electronic device to short-circuit and may, in turn, cause the portable electronic device to catch fire and/or at least present a shock hazard.

It is therefore desirable to find a system and a method for protecting portable electronic device from impact.

### SUMMARY

In accordance with a present embodiment, a system for protecting a portable electronic device includes an accelerometer and a processor. The accelerometer is configured (i.e., structured and arranged) to measure an acceleration of the portable electronic device in at least one direction and to generate a signal proportional to the acceleration. The processor is configured to receive the signal from the accelerometer and compare the signal with a preset value in order to judge whether an at least one of an unacceptable fall and an unacceptable impact is occurring. The processor is further configured to activate a routine to shut down the portable electronic device if the at least one of an unacceptable fall and an unacceptable impact is detected.

In accordance with another present embodiment, a method for protecting a portable electronic device includes the steps of: measuring an acceleration of the portable electronic device and generating a signal proportional to the acceleration; comparing the signal with a preset value; judging whether at least one of an unacceptable fall and an unacceptable impact is occurring; and shutting down the portable electronic device if the at least one of an unacceptable fall and an unacceptable impact is occurring.

In accordance with a further present embodiment, a portable electronic device includes an electrical source, a storage device, a switch, and a system for protecting the portable electronic device. The storage device and the system are connected to the electrical source, via the switch. The system for protecting a portable electronic device includes an accelerometer and a processor. The accelerometer is configured to measure an acceleration of the portable electronic device in at least one direction and to generate a signal proportional to the acceleration. The processor is configured to receive the signal from the accelerometer and compare the signal with a preset value in order to judge whether an at least one of an unacceptable fall and an unacceptable impact is occurring. The processor is further configured to activate a routine to shut down the portable electronic device if the at least one of an unacceptable fall and an unacceptable impact is detected.

### BRIEF DESCRIPTION OF THE DRAWING

Many aspects of embodiments can be better understood with reference to the following drawings. The components in the drawings are not necessarily drawn to scale, the emphasis instead being placed upon clearly illustrating the principles of the present system and method for protecting portable electronic device from impact. Moreover, in the drawings, like reference numerals designate corresponding parts throughout the several views.

FIG. 1 is a schematic, functional block diagram showing components of a portable electronic device, according to a present embodiment; and

FIG. 2 is a flow chart of a method for protecting the portable electronic device, according to a present embodiment.

### DETAILED DESCRIPTION OF THE EMBODIMENTS

Embodiments of the present system and method for protecting portable electronic device from impact will now be described in detail below with reference to the drawings.

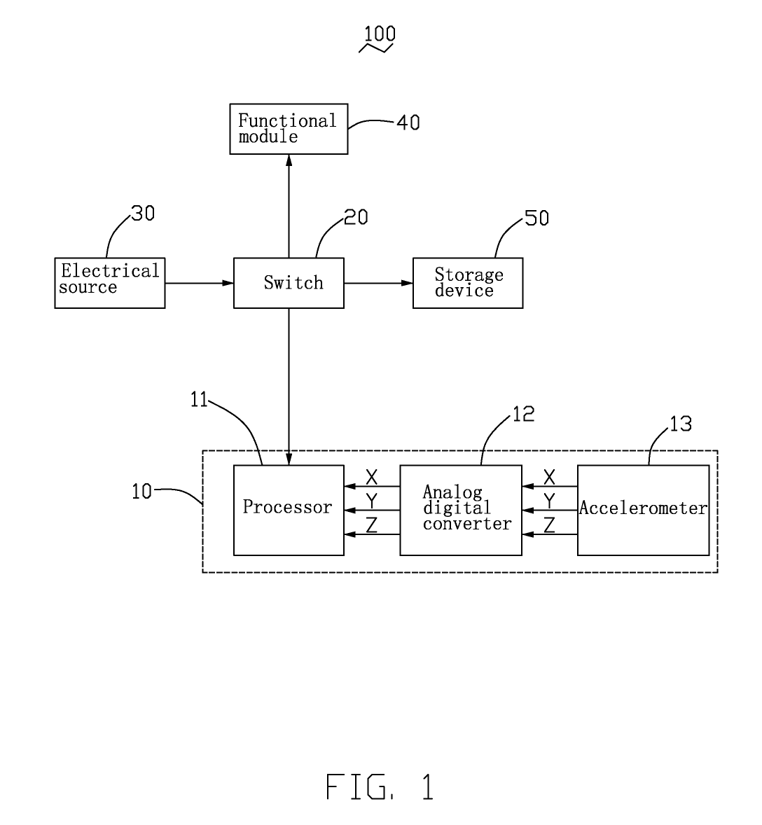

Referring to FIG. 1, a portable electronic device 100, according to an embodiment, is shown. The portable electronic device 100 includes a system 10 for protecting the portable electronic device 100, a switch 20, an electrical source 30, a functional module 40, and a storage device 50.

The portable electronic device 100 can be a computing device such as a notebook/portable computer or a personal digital assistant (PDA), a communication device such as a wireless telephone, or a media device such as a CD, a DVD, or an MP3 player. The system 10, the functional module 40, and the storage device 50 are connected to the electrical source 30, via the switch 20. The electrical source 30 (e.g., a battery or a cord link to an outlet) provides power to other components of the portable electronic device 100. The functional module 40 is a device for carrying out a function for the portable electronic device 100, and the functional module 40 can be an audio transceiver (e.g., phone), a camera module, a LCD monitor, and so on. The storage device 50 is used for accessing data from the portable electronic device 100.

In a present embodiment, the system 10 further includes an accelerometer 13, an analog digital converter 12, and a processor 11. The analog digital converter 12 is electronically coupled (e.g., hard-wire or wireless link) between the accelerometer 13 and the processor 11.

The accelerometer 13 is received in the portable electronic device 100. Advantageously, the accelerometer 13 can be secured, for example, on a shell/cover or a circuit board of the portable electronic device 100. The accelerometer 13 is configured to measure an acceleration of the portable electronic device 100 in at least one direction and generate a signal proportional to the acceleration. The signal can be a voltage signal proportional to the acceleration or other such indicator. Preferably, the accelerometer 13 is a three axes accelerometer, which can measure acceleration along X axis, Y axis, and Z axis, as appropriate, with the X axis, Y axis, and Z axis being perpendicular to each other (i.e., standard X-Y-Z axis system).

Because the signal generated by the accelerometer 13 is usually an analog signal, the analog digital converter 12 is beneficially used for converting the analog signal to a digital signal, which may then be easily processed by the processor 11.

The processor 11 can receive the signal generated by the accelerometer 13, and compare the signal of the portable electronic device 100 with a preset value, in order to judge whether a fall (i.e., measured in terms of a rapid acceleration) and/or an impact (i.e., measured in terms of a rapid deceleration) is occurring. The preset value is chosen to represent an acceleration level that would suggest an impending impact (i.e., if an actual (not impending) impact being measured, the acceleration level could be a measurement of rapid deceleration). The preset value can, usefully, be set based on a maximum force of impact that the portable electronic device 100 can withstand (i.e., a short-distance drop might be deemed acceptable). If the acceleration level (e.g., an absolute value of acceleration) of the portable electronic device 100 is determined to be greater than the acceleration level of the preset value represented and thus an unacceptable fall and/or an impact is occurring, the processor 11 then activates a routine to shut down the portable electronic device 100 to prevent the portable electronic device 100 from being further damaged (e.g., from a system short induced by such an impact). In the portable electronic device 100, the processor 11 continuously monitors the signal generated by the accelerometer 13.

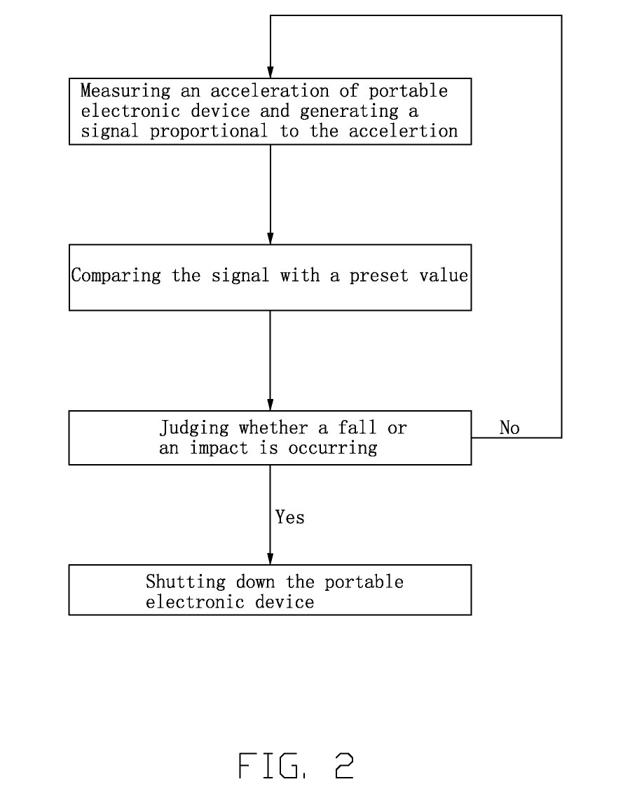

A method for protecting the portable electronic device 100 is also provided. Referring to FIG. 2, the method includes the steps of: measuring an acceleration of the portable electronic device 100 and generating a signal proportional to the acceleration; comparing the signal with a preset value; judging whether a fall and/or an impact is occurring; and shutting down the portable electronic device 100, if a fall and/or an impact is occurring.

In a present embodiment, the accelerometer 13 is configured for measuring an acceleration of the portable electronic device 100 and generating a signal proportional to the acceleration. The processor 11 is configured for comparing the signal with a preset value and judging whether a fall or an impact is occurring. Further, if a fall or an impact is occurring, the processor 11 is configured to activate a routine for shutting down the portable electronic device 100. The method also includes a step of going back to the step of measuring an acceleration of the portable electronic device 100, if a fall or an impact is not occurring (i.e., effectively permitting continuous acceleration monitoring while in an “on” state). In a present embodiment, if the acceleration of the portable electronic device 100 is greater than the acceleration of the preset value represented, the processor 111 would judge that a fall and/or an impact is occurring and/or about to occur. Because the signal generated by the accelerometer 13 is usually an analog signal, the method can also include a step of converting the signal generated by the accelerometer from analog to digital, before comparing the acceleration with the preset value.

As stated above, the system and method for protecting a portable electronic device shuts down the portable electronic device if it is judged that a fall and/or an impact is occurring, thus protecting the device from short-circuiting due to adverse effects of an impact.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A system for protecting a portable electronic device comprising:
an accelerometer configured to measure an acceleration of the portable electronic device in at least one direction and to generate a signal proportional to the acceleration; and
a processor configured to receive the signal from the accelerometer and compare the signal with a preset value in order to judge whether an at least one of an unacceptable fall and an unacceptable impact is occurring, the processor being further configured to activate a routine to shut down the portable electronic device if the at least one of an unacceptable fall and an unacceptable impact is detected.

2. The system as claimed in claim 1, wherein the accelerometer is a three axes accelerometer.

3. The system as claimed in claim 1, wherein the signal proportional to the acceleration generated by the accelerometer is a voltage signal.

4. The system as claimed in claim 1, wherein the system further comprising an analog digital converter electronically coupled between the accelerometer and the processor, the analog digital converter being configured for analog-digital converting the signal generated by the accelerometer.

5. The system as claimed in claim 1, wherein the processor is configured for judging if at least one of an unacceptable fall and an unacceptable impact is occurring by determining if the acceleration level of the portable electronic device is larger than the acceleration level of the preset value.

6. A method for protecting a portable electronic device, comprising the steps of:
measuring an acceleration of the portable electronic device and generating a signal proportional to the acceleration;
comparing the signal with a preset value;
judging whether at least one of an unacceptable fall and an unacceptable impact is occurring; and
shutting down the portable electronic device if the at least one of an unacceptable fall and an unacceptable impact is occurring.

7. The method as claimed in claim 6, wherein, after judging whether the at least one of an unacceptable fall and an unacceptable impact is occurring, the method further comprises a step of going back to the step of measuring an acceleration of the portable electronic device, if it is judged that the at least one of an unacceptable fall and an unacceptable impact is not occurring.

8. The method as claimed in claim 6, wherein, before comparing the acceleration with a preset value, the method further comprises a step converting the signal generated by the accelerometer from analog to digital.

9. The method as claimed in claim 6, wherein the accelerometer is a three axes accelerometer.

10. The method as claimed in claim 6, wherein the signal proportional to the acceleration generated by the accelerometer is a voltage signal.

11. The method as claimed in claim 6, wherein the at least one of an unacceptable fall and an unacceptable impact is judged as occurring, if the acceleration level of the portable electronic device is larger than the acceleration level of the preset value.

12. A portable electronic device comprising: an electrical source, a storage device, a switch, and a system for protecting the portable electronic device, the storage device and the system being connected to the electrical source via the switch, the system for protecting a portable electronic device comprising:
an accelerometer configured to measure an acceleration of the portable electronic device in at least one direction and generate a signal proportional to the acceleration; and
a processor configured to receive the signal from the accelerometer and compare the signal with a preset value to judge whether at least one of an unacceptable fall and an unacceptable impact is occurring, the processor being further configured to activate a routine to shut down the portable electronic device, if the at least one of an unacceptable fall and an unacceptable impact is occurring.

13. The portable electronic device as claimed in claim 12, wherein the accelerometer is a three axes accelerometer.

14. The portable electronic device as claimed in claim 12, wherein the signal proportional to the acceleration generated by the accelerometer is a voltage signal.

15. The portable electronic device as claimed in claim 12, wherein the system further comprising an analog digital converter electronically coupled between the accelerometer and the processor for analog-digital converting the signal generated by the accelerometer.

16. The portable electronic device as claimed in claim 12, wherein the processor is configured for judging if the at least one of an unacceptable fall and an unacceptable impact is occurring by determining if the acceleration level of the portable electronic device is larger than the acceleration level of the preset value.
